(19) United States
(12) Patent Application Publication
(10) Pub. No.: US 2014/0196071 A1
(43) Pub. Date: Jul. 10, 2014

(54) RENDERING DEVICE WITH CONTENT SUBSTITUTION

(71) Applicants: Alex Dick Terpstra, Eindhoven (NL); Martijn Maas, Eindhoven (NL); Mehmet Utku Celik, Eindhoven (NL); Jaap Andre Haitsma, Eindhoven (NL)

(72) Inventors: Alex Dick Terpstra, Eindhoven (NL); Martijn Maas, Eindhoven (NL); Mehmet Utku Celik, Eindhoven (NL); Jaap Andre Haitsma, Eindhoven (NL)

(73) Assignee: CIVOLUTION B.V., Eindhoven (NL)

(21) Appl. No.: 14/127,432

(22) PCT Filed: Jun. 20, 2012
(86) PCT No.: PCT/NL2012/050430

§ 371 Date: Feb. 13, 2014

(30) Foreign Application Priority Data
Jun. 21, 2011 (NL) 2006978

(51) Int. Cl. H04N 21/44; H04N 21/81; H04N 21/8358; H04N 21/462

(52) U.S. Cl. CPC H04N 21/44016; H04N 21/44008; H04N 21/4622; H04N 21/812; H04N 21/8358
USPC 725/19; 725/36

(57) ABSTRACT

A device for rendering content from a first source comprising a first input for receiving the content from the first source, a second input for receiving a substitution content item from a second source, a substitution module for substituting a segment of the content with the substitution content item, and rendering means for rendering the content wherein the segment is substituted with the substitution content item. The rendering device has monitoring module for monitoring the reception of the segment, and controlling the substitution module dependent on whether the segment is being received, such that the substitution module ceases the substitution upon failure to receive the segment.

### FIELD OF THE INVENTION

The invention relates to a device for rendering content from a first source comprising substitution module for substituting a segment of the content with a content item from a second source.

### BACKGROUND OF THE INVENTION

An advertisement placed in broadcast television or radio programming has the advantage of having a wide reach; millions of households see the same advertisement. On the other hand, broadcasting a single advertisement to all viewers is likely to have a low response rate as the advertisement is necessarily very generic. A significant improvement in consumer response rate is achieved when the advertisement is targeted to an individual household or even an individual viewer.

For example, a car manufacturer may have different commercials for cars in low and high price categories. A commercial embedded in a television signal has to address the widest audience and so would advertise the lower-priced car. If the preference profile of a particular viewer reveals that this viewer has a high income, the advertiser wants the commercial to be replaced by the one for the higher price category. As a consequence a targeted advertisement generates significantly more revenue than a regular advertisement.

The concept of advertisement replacement in devices such as set-top boxes by itself is known. Typically this involves building up a preference profile for the viewer or household, and downloading advertisements to a rendering device (e.g. television or radio) that well suit the preference profile. The downloaded advertisements are kept in local storage and substituted whenever the device detects the presence (or, more particularly, the beginning) of an advertisement in the incoming content stream.

Such advertisement substitution is usually controlled by a cable or satellite operator that provides signal transmission to end users operating on the set-top boxes (STBs) that descramble and decode broadcast signals. In that situation, the operator has control over the broadcast stream and can place swap codes in the broadcast stream to signal when the advertisement will arrive. However, in other situations content substitution is more difficult.

Such other situation may arise when content substitution is performed in the rendering device itself, wherein the content is supplied to the rendering device from an external origin, e.g. another device such as a set-top box as a first source. The external device selects the content from a plurality of channels to supply it to the rendering device. In that situation, the external device may switch to different content while the content substitution in the rendering device is in progress, for example when the user changes the channel on the set-top box, switches from television signals to DVD playback or calls up an electronic program guide or Teletext service.

In that situation, the content of the first source changes, but the rendering device is unable to detect this switch. The external device only delivers a single signal, seamlessly switching its content as the user selects other content or another content source. As a result, since normally the substitution only ceases when the substitution content finishes, the rendering device would continue the segment substitution, and only present the newly selected content, e.g. another channel, after the substitution content item has finished. This is undesirable as it conflicts with viewer expectations: if the viewer switches to another channel, this channel should display immediately and the currently-playing advertisement should cease.

It should be noted that while the discussion above is in the context of advertisement replacement, the problem—and solution—is more generic in nature and could also be used to substitute different kinds of content. For example, one may replace a news segment with a local news segment, or substitute a song or other audio track in the content at the first source with an audio track from the second source.

### SUMMARY

The invention solves the above-mentioned technical problem by a device for rendering content from a first source comprising a first input for receiving the content from the first source, a second input for receiving a substitution content item from a second source, substitution module for substituting a segment of the content with the substitution content item, and rendering means for rendering the content wherein the segment is substituted with the substitution content item. The rendering device has a monitoring module for monitoring the reception of the segment, and controlling the substitution module dependent on the segment is being received, such that the substitution module ceases the substitution of the segment by the substitution content item upon failure to receive the segment.

The segment is the part of the content which is to be substituted by the substitution content item. When the segment is no longer being received, due to at least one of removal or finishing of the segment, change to a different source and any other disturbance or interruption, detected by the monitoring module, the substitution module must stop the substituting process.

In an embodiment the monitoring module comprises a first watermark detector configured for detecting a substitution watermark in one or more initial frames of the segment and controlling the substitution module to initiate the substitution upon such detection. This embodiment allows easy detection of the start of the segment through detection of the substitution watermark. The substitution watermark can be a simple low-bit watermark that only serves the purpose of indicating that the segment may be substituted by alternative content. Optionally, the watermark can carry more information, e.g. indicating the length of the segment or even metadata comprising e.g. the type of product or the target audience. With that metadata a better selection of the substitute content item can be made. By having this watermark in one of the first few frames, the device can easily determine that the substitution is to take place. Exactly which one or more initial frames are used depends on the watermarking algorithm and the way the detector operates. The phrase is not intended to mean only the very first frame.

In a further embodiment the monitoring module comprise a second watermark detector for detecting a segment watermark embedded in the segment, wherein the monitoring module is arranged to control the substitution module to cease the substitution when the segment watermark. The segment watermark may be a straightforward low-bit watermark that serves the purpose of indicating the fact that the segment is still being received. Such a low-bit watermark is easier to detect than a watermark providing a unique segment identifier.

In an improvement to this embodiment, the segment watermark detector is further arranged for extracting an identifier from the segment watermark, and the substitution module are configured to select the substitute content item based at least on the identifier. With a segment watermark having an identifier, advertisement (or other content) substitution of the segment can be done accurately. The device may have access to a list that maps the segment identifiers to one or plural associated substitute advertisements to facilitate selection. Alternatively the segment identifier may be associated with locally available metadata, indicating e.g. the type of product or the target audience. With that metadata a better selection of the substitute content item can be made.

In a further embodiment the monitoring module comprises a fingerprint calculator for calculating a content fingerprint for the segment and a matching module for matching the calculated content fingerprint against a set of records, the substitution module being configured for controlling the substitution module to initiate the substitution upon the matching module detecting a match between the calculated content fingerprint and the set of records. Here digital content fingerprinting is used instead of watermarking as in the above embodiments.

With digital fingerprinting content can be identified by extracting characteristic features of the content and comparing those against one or more reference records with characteristic features of various segments. The reference records can be available in a local storage means. Alternatively the reference records may be available from a remote source, such as an Internet service to retrieve information for a fingerprint or a storage device in a local network to which the device is connected.

In an improvement of this embodiment the substitution module are configured to select the content item based at least on the calculated content fingerprint. Like an identifying watermark, advertisement (or other content) substitution of the segment can be done accurately based on the identifying fingerprint.

In another embodiment the monitoring module comprises a fingerprint calculator for calculating a content fingerprint for the segment, and a matching means for matching the calculated content fingerprint against a set of records, the monitoring module being configured for controlling the substitution module upon the matching means detecting a mismatch between the calculated content fingerprint and the set of records to cease the substitution of the segment with the substitution content item. By continuously fingerprinting the content from the original source, a mismatch can be easily detected.

In an embodiment, the set of records is available from a remote source, such as an Internet service to retrieve information for a fingerprint or a storage device in a local network to which the device is connected. This allows a content provider who wants to enable the rendering device to perform the content substitution to update the records used for the fingerprinting and keep control over the substitution process.

In a further embodiment the fingerprint calculator and/or the matching means are comprised in an external device with which the device communicates over a network such as the Internet or a local network, allowing the rendering device to be as slim as possible and allow the content provider to keep control over the substitution process.

In another embodiment the monitoring module is configured for detecting a disturbance in the reception of the segment and causing the substitution module to cease substitution upon detection of the disturbance. This allows ceasing the substitution when a user selects another source for the content or otherwise such that an interruption in receiving the segment being substituted by the substitution content item occurs.

In a further embodiment the segment is substituted by a sequence of plural content items from the second source whose combined length approximates the length of the segment. The segment may be substituted by a single locally available content item, which requires that the content item be substantially the same length as the segment. This may not be feasible in all situations. By substituting plural items this disadvantage can be overcome. In an embodiment the device comprises a processor, a memory, programmable with executable instructions wherein the monitoring module and substitution module in operation are performed by the executable instructions. This allows a flexible set up of the rendering device which functionality can also be updated and improved remotely. The problem is also solved according to the invention in a method for rendering content form a first source in a rendering device, the method comprising receiving the content having a first segment, receiving a substitution content item from a second source, substituting the segment by the substitution content item, rendering the substitution content item. The method further comprises according to the invention continuously monitoring the receiving of the segment in the content, and ceasing the substitution the segment with the substitution content item upon failure of the receiving of the segment. The problem is also solved in a computer program product, comprising a data carrier, having stored thereon executable instructions, which when loaded and executed by a rendering device having a processor and memory as described, perform the steps of the method as described above.

### BRIEF DESCRIPTION OF THE DRAWINGS

The invention will now be elaborated upon with reference to the drawings, in which

FIG. 1 schematically shows a device for rendering content from a first source;

FIG. 2 schematically shows an embodiment of the device that employs watermark detection;

FIG. 3 schematically shows an embodiment of the device that employs content fingerprinting; and

FIG. 4 schematically shows an embodiment of the device that employs a combination of watermarking and fingerprinting.

In the figures, like reference numbers indicate like or similar features.

### DETAILED DESCRIPTION

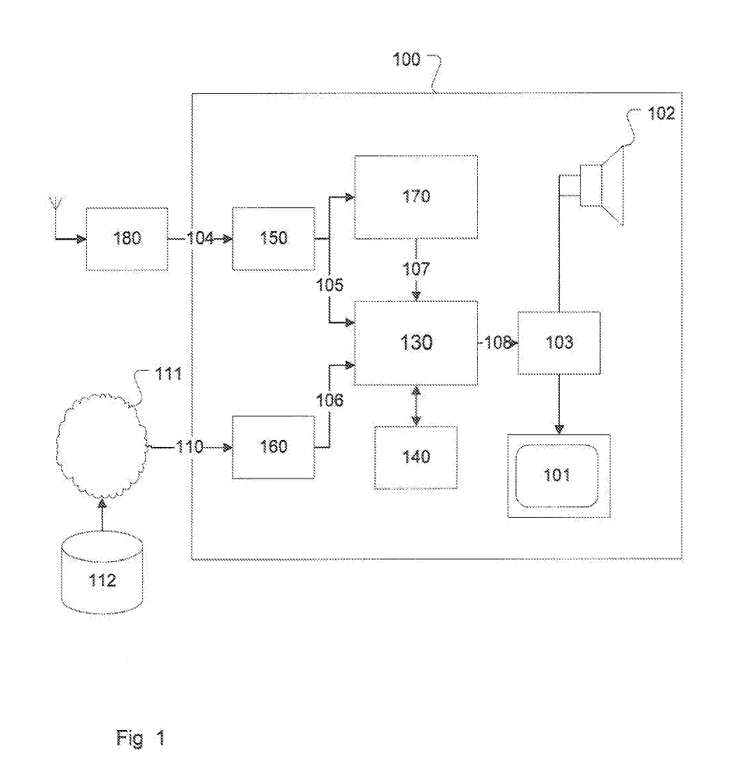

FIG. 1 schematically shows a device 100 for rendering content from a first input 150. In FIG. 1, the device 100 is embodied as a television with display 101 and loudspeakers 102, coupled to rendering module 103 which decodes, processes and renders the content from input 150 using these output devices 101, 102. In FIG. 1 the first input 150 is coupled to an external device 180, as shown a set-top box, acting as a source that in turn receives the content from yet other sources such as over-the-air, cable or IP-based transmission. The first input 150 may for example also be a device for reading pre-stored substitution content items, such as a DVD or CD player for receiving a pre-recorded disc or an Universal Serial Bus (USB) port for connecting to an USB memory device having the pre-recorded items. The content may be of analog or digital nature, and can comprise any type of data, but preferably comprises audio and/or video data. The first input 150 may be provided with an internal storage such as a hard disk for receiving content which may be stored and rendered in a later stage.

Input 150 and external device 180 are preferably connected via a standard connector 104 such as HDMI, and optionally employ a content protection mechanism such as HDCP to ensure that content is provided only between compliant devices. A variety of connecting mechanisms, employing wires or wireless technology, is available.

While the invention is presented here in the context of television display devices, the invention also is useful for other programmable devices that provide the ability to render content, such as radios, laptops, desktop computers, smartphones and netbooks.

The device 100 comprises a substitution module 130 connected via connection 105 to the first input 150 and connected to the second input 160 via connection 106. The substitution module 130 is configured for substituting a segment of the content from the first input 150 with a content item from a second input 160. The substitution module 130 then causes via connection 108 the rendering module 103 to render this substitution content item instead of the segment from the first input 150. After the substitution content item has finished rendering, the substitution module 130 causes the rendering module 103 to resume rendering the content from the first input 150. It is usually desired that the substitution content item and the segment are of substantially the same length to ensure the substitution is smooth and hardly noticeable to the viewer. Instead of a single content item, the segment from the first input 150 may also substituted by a sequence of plural content items from the second input 160 whose combined length approximates the length of the segment.

The second input 160 may be a coupling 110 via a data network 111 to an external source 112 for substitution content items such as an Internet Protocol-based communication channel from which the content item is obtained, e.g. from a network-attached storage device in a home network. The second input 160 can be equipped with an internal storage medium such as an internal hard disk or similar storage medium, allowing the desired substitution content item(s) to be received well before the substitution is to occur. The second input 160 may for example also be a device for reading pre-stored substitution content items, such as a DVD or CD player for receiving a pre-recorded disc or an Universal Serial Bus (USB) port for connecting to an USB memory device having the pre-recorded items.

The substitution module 130 may select the substitution content item from the second input 160 in a variety of ways. Preferably, the substitution module 130 is coupled to a profiling module 140 that maintains a preference profile based on content that is being rendered and/or user input and/or other relevant sources of information. Maintaining such profiles and selecting content based on a profile is well-known in the art and will not be elaborated upon. In this embodiment the selected content item will be a close match with the viewer's personal preferences and/or interests.

Alternatively to the previous embodiment, the substitution module 130 may select the substitution content item from the second input 160 based on an identifier for the segment. Preferably in this embodiment the substitution content items available from the second input 160 carry indications, e.g. a metadata record, for which identifiers they are an appropriate substitute. Alternatively a list of mappings of identifiers to content at the second input 160 could be provided in another way.

These two embodiments may also be combined, in which case a high level of matching the selected substitution content item with the viewer's personal preferences and/or interests may occur. Other ways of selecting the content item from the second input 160 may of course also be used.

The segment from the first input 150 and the substitution content item from the second input 160 are typically advertisements, in which case the device 100 is used to provide substitute advertisements for the advertisements contained in the content from the first input 150. Alternatively the segment and its substitute may comprise other types of content, for example music, audio dialogue dubs, child-friendly versions of content, local news or weather reports or subtitles in a different language.

The device 100 further comprises a monitoring module 170 connected via connection 105 to the first input 150 and via connection 107 with the substitution module 107 of controlling the substitution process. The monitoring module 170 is configured for continuously monitoring the first input 150 while the substitution module 130 is causing via connection 107 the substitution content item from the second input 160 to be rendered. Monitoring module 170 receives the content from an external source having the segment to be substituted. The monitoring module 170 is provided with a detector for detecting when the substitution should start.

Detection of the start of a segment for substitution can be performed in a variety of ways. In some situations, the commercials or other segments from the first input 150 can be recognized with embedded codes, e.g. in a vertical blanking interval. In other situations, an examination of content characteristics typically associated with the type of content to be substituted can be performed. For example, the appearance of one or more black frames together with a significant change in audio volume is indicative of a transition to a commercial break. Several techniques are known in the art to detect commercial breaks or other types of content changes.

Once the start of the substitution is detected, the monitoring module 170 monitors that the segment to be substituted is continuously received from the first input 150. As long as the segment is received, the substitution may continue. However, upon failing to receive the segment, monitoring module 170 signals the substitution module 130 to cease the substitution. This in turn causes the rendering module 103 to resume rendering the content from the first input 150.

The monitoring module 170 may employ a variety of techniques to monitor the segment being received. For example, where the beginning of the segment has been previously detected, the monitoring module 170 may scan for disturbances in the content received from the first input such as interruptions or glitches, e.g. black frames, silences, partial frames, optionally in combination with audio glitches or silence, which typically indicate that the segment is no longer being received from the first input 150. For instance, when dealing with digital audio-visual signals, the reception of several substantially black frames accompanied by a first audio glitch followed by silence is characteristic of the signal having changed from a first channel to a second channel. This characteristic is caused by the fact that the channel change requires a flush of the content buffer (both audio and video) and the reception of the first I-frame of the new channel.

When a disturbance in the segment has been detected, the monitoring module 170 assumes that the segment is no longer received and signals to the substitution module 130 that the substitution must cease. The monitoring of the segment being received may comprise some kind of verification or check to compensate for a false detection that is not due to an actual absence of the segment. A video frame could for example be corrupted or missing due to transmission errors, but that should not cause the monitoring module 170 to conclude that rendering must resume from the first input 150. To avoid this kind of mistaken conclusion, the monitoring module 170 is optionally configured to only signal the substitution module 130 to cease substitution if the disturbances persist for say three or five, frames. Whether this verification is useful depends on the type of content, the way the disturbances may be present and the chance of errors that may obscure, corrupt or omit the detection of these disturbances.

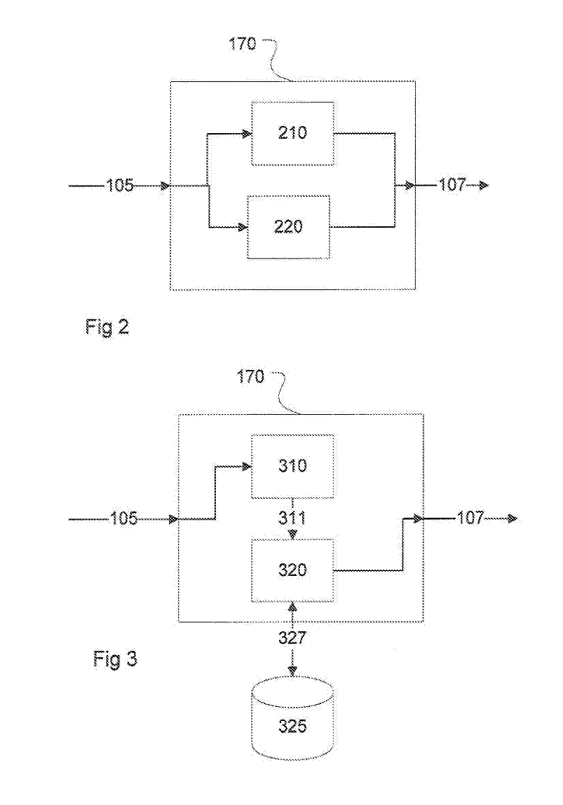

FIG. 2 schematically shows an embodiment of the device 100 that employs watermark detection for monitoring the first source, that the segment for substitution is being received. Watermarks are, generally speaking, markers in the content that are imperceptible to human senses but that can be detected using appropriate hardware and/or software. Thus, with a watermark it is possible to convey information to the device 100 by manipulating the content to insert the appropriate markers. Watermarking as a technology is well-known.

In FIG. 2 the monitoring module 170 further comprises a substitution watermark detector 210 which is configured for continuously monitoring the content received from the first input 150 in order to detect a particular watermark therein. This particular watermark serves to indicate the beginning of a segment for which content substitution may be performed. Thus, it will typically be present in initial frames of the segment, preferably somewhere in the first second of the segment. Upon detection of this particular watermark, the watermark detector 210 signals via connection 107 to the substitution module 130 that the substitution of the segment with a content item from the second input 160 is to be initiated.

Moreover, the monitoring device 170 comprises a segment watermark detector 220 for detecting a segment watermark embedded in the entire segment. This watermark detector 220 continuously monitors the first input 150 while the substitution module 130 is causing the substitution content item from the second input 160 to be rendered instead of the segment. As long as the segment watermark is being detected, the substitution may continue. However, upon the watermark detector 220 failing to detect the segment watermark, monitoring module 170 signals 107 the substitution module 130 to cease the substitution. This in turn causes the rendering module to resume rendering the content from the first input 150. The watermark detector 220 may employ a verification to ensure that a single mismatch does not trigger the switching back to the first input 150.

The segment watermark can be a simple low-bit watermark that merely indicates that the segment is still present in the content from the first input 150. Alternatively the segment watermark may provide an identifier for the segment. This identifier can be specific to the segment, or be a more generic identifier such as “this content is an advertisement for a car” or “this content is a weather announcement”. This identifier is then supplied to the substitution module 130 to be part of the selection of the content item from the second input 160.

In practice the two watermark detectors 210, 220 may be combined into a single watermark detector that can detect both the watermark indicating the beginning of a segment and the watermark that indicates the continued reception of the segment. These two watermarks can be one and the same: a watermark that indicates “this segment is an advertisement” or provides an identifier for the watermark does not necessarily need to be different in initial and subsequent frames.

The watermark in the initial frames may be optimized for fast detection to allow a fast switch to the second input 160. In contrast, the segment watermark in the subsequent frames that serves to indicate the continuous presence of the segment may be optimized for other purposes.

FIG. 3 schematically shows an embodiment of the device 100 that employs content fingerprinting. Content fingerprinting is a technique wherein perceptually relevant features of a content segment are processed and combined into a code—the fingerprint—that is unique for the segment and that is the same even if the segment is slightly altered, for example when transcoding from one format to another or when resizing or rotating the segment. Unlike watermarking, content fingerprinting does not need to alter the signal itself. Content fingerprinting is sometimes also known as robust fingerprinting or robust hashing.

In FIG. 3, the monitoring module 130 comprises a fingerprint calculator 310 which is configured for calculating a content fingerprint 311 for the segment. The calculator 310 is coupled to a matching module 320 that attempts to match the calculated content fingerprint 311 against a set of records of pre-calculated fingerprints, as shown available from database 325. If a match occurs, the matching module 320 signals to the substitution module 130 that the substitution is to be initiated. Fingerprint calculation and matching as such is a well-known technique.

The content fingerprint 311 is preferably based on a set of frames near the beginning of the content instead of the whole segment, allowing the substitution to begin as soon as a match with the fingerprint is found. As shown, database 325 is local to the device 100. The records in database 325 may alternatively be available from a remote source, e.g. using an Internet service to retrieve information for a fingerprint or connecting to a network storage device in the home network that contains the information.

In an alternative embodiment the fingerprint calculator 310 and/or matching module 320 is or are placed outside of the device 100. The device 100 then communicates with these modules 310 and/or 320 over a network, e.g. the home network or the Internet. This way the device 100 does not have to be equipped with these modules 310, 320 itself, which saves costs. Further, one device comprising these modules 310, 320 may be deployed for a multitude of devices like device 100.

In a preferred embodiment the substitution module 130 is configured to select the content item from the second input 160 based at least on the calculated content fingerprint in the segment to be substituted from the first input 150. The fingerprint is unique for the segment and thus may serve as an identifier for a selection of the substitution content item, allowing content-specific substitution to be performed.

Alternatively or in combination with the matching disclosed above, the fingerprint calculator 310 is configured to calculate a content fingerprint 311 for the segment. This calculated indication fingerprint 311 then must be matched against a set of records, e.g. from database 325, to determine if the calculated fingerprint 311 is still part of the segment. If so, the monitoring module 170 establishes that the segment to be substituted is present. Typically this fingerprint is calculated separately for each frame or other elementary part of the segment as received from input 150. The set of records 325 provides a set of reference fingerprints comprising a reference fingerprint 327 for each elementary part of the segment.

As long as the fingerprint 311 is detected, the substitution may continue. However, as soon as the calculated fingerprint 311 differs from the corresponding reference fingerprint 327, the monitoring module 170 signals the substitution module 130 to cease the substitution. This in turn causes the rendering module 103 to resume rendering the content from the first input 150. The fingerprint calculator 310 may employ a verification to ensure that a single mismatch does not trigger the switching back to the first input 150. In a variation of this embodiment the device 100 employs segment watermark detector 220 in combination with fingerprint detection. After the matching module 320 has signalled 107 to the substitution module 130 that the substitution is to be initiated, the watermark detector 220 is activated and searches for the substitution watermark embedded in the segment. Upon failing to detect the substitution watermark, monitoring module 170 signals the substitution module 130 to cease the substitution.

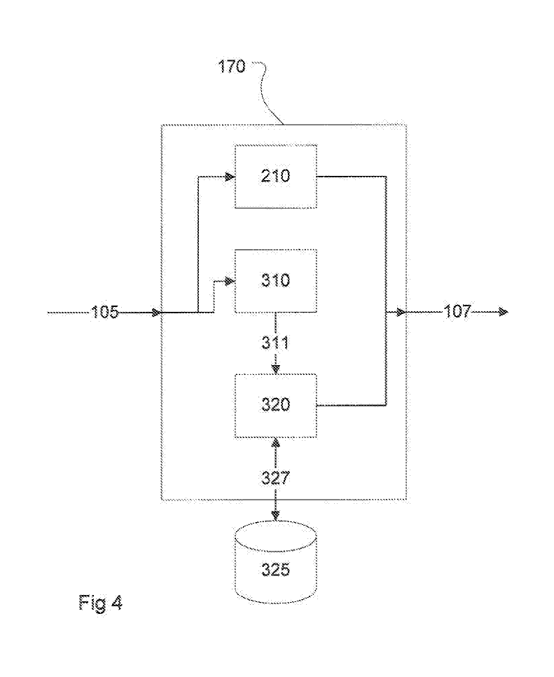

FIG. 4 schematically shows an embodiment of the device 100 that employs a combination of watermarking and fingerprinting as disclosed previously. In this embodiment, the substitution watermark detector 210 is used to detect a segment from the first input 150 for which content substitution is to be performed. While substitution is being performed, the fingerprint calculator 310 is used to continuously calculate the content fingerprint 311 for the segment. As soon as the calculated fingerprint 311 differs from a corresponding reference fingerprint 327, the monitoring module 170 signals 107 the substitution module 130 to cease the substitution.

This combined embodiment employs the benefit of watermark detection for recognizing segments that may be substituted with the benefits of content fingerprinting for monitoring the segment while substitution takes place.

The above provides a description of several useful embodiments that serve to illustrate and describe the invention. The description is not intended to be an exhaustive description of all possible ways in which the invention can be implemented or used. The skilled person will be able to think of many modifications and variations that still rely on the essential features of the invention as presented in the claims. In addition, well-known methods, procedures, components, and circuits have not been described in detail.

The invention can be implemented in a computer program product, i.e. a collection of computer program instructions stored on a computer readable storage device for execution by a processor. The instructions of the present invention may be in any interpretable or executable code mechanism, including but not limited to scripts, interpretable programs, dynamic link libraries (DLLs) or Java classes. The instructions can be provided as complete executable programs, as modifications to existing programs or extensions (“plug-ins”) for existing programs. Moreover, parts of the processing of the present invention may be distributed over multiple computers or processors for better performance, reliability, and/or cost.

Machine-readable storage devices suitable for storing computer program instructions include all forms of non-volatile memory, including by way of example semiconductor memory devices, such as ROM, RAM, EPROM, EEPROM, and flash memory devices, magnetic disks such as the internal and external hard disk drives and removable disks, magneto-optical disks and CD-ROM disks. The computer program product can be distributed on such a storage device, or may be offered for download through HTTP, FTP or similar mechanism using a server connected to a network such as the Internet. To this end one may connect a server system comprising the storage medium discussed above to a network, and arrange this server for allowing the instructions to be downloaded to client systems connected directly or indirectly to the network.

The computer program instructions may be loaded into a memory and be executed on a processor embedded in the rendering device as described above. This way the processor while executing the computer program instructions implement the various modules and functions, such as the monitoring module 170, the substitution module 130, the segment watermark detector 210, the substitution watermark detector 220, the fingerprint calculator 310, the fingerprint matching module 320 as described. The embedded processor is connected to the memory to allow the program to be loaded and executed. The processor can be further communicatively connected to the first and second inputs 150, 160 and the rendering device 103.

When constructing or interpreting the claims, any mention of reference signs shall not be regarded as a limitation of the claimed feature to the referenced feature or embodiment. The use of the word “comprising” in the claims does not exclude the presence of other features than claimed in a system, product or method implementing the invention. Any reference to a claim feature in the singular shall not exclude the presence of a plurality of this feature. The word “means” in a claim can refer to a single means or to plural means for providing the indicated function.

1.-14. (canceled)

15. A device for rendering content from a first source comprising:
a first input for receiving the content from the first source,
a second input for receiving a substitution content item from a second source,
substituting means for substituting a segment of the content with the substitution content item,
characterized by
monitoring means for monitoring receiving of the segment from the first source, and controlling the substituting means to cease the substituting dependent on the receiving of the segment, such that the substitution means cease the substituting when the receiving of the segment ceases.

16. The device according to claim 15, wherein the monitoring means comprises a first watermark detector configured for detecting a watermark in one or more initial frames of the segment and for controlling the substituting means to initiate the substitution upon such detection.

17. The device according to claim 15, in which the monitoring means comprise a second watermark detector for detecting a watermark embedded in the segment, and wherein the monitoring means are arranged to control the substituting means to cease the replacement when the watermark embedded in the segment is not detected.

18. The device according to claim 17, wherein the second watermark detector is arranged to extract an identifier from a watermark in the segment, and wherein the substituting means are configured to select the substitution content item based on the identifier.

19. The device according to claim 15, wherein the monitoring means comprise a fingerprint calculator for calculating a content fingerprint for the segment and a matching means for matching the calculated content fingerprint against a set of records.

20. The device according to claim 19, wherein the monitoring means controls the substituting means for initiating the substituting upon the matching means detecting a match between the calculated content fingerprint and the set of records.

21. The device according to claim 20, wherein the substituting means are configured to select the content item based at least on the calculated content fingerprint.

22. The device according to claim 19, wherein the monitoring means are configured for causing the substituting means to cease the substitution upon the matching means detecting a mismatch between the calculated content fingerprint and the set of records.

23. The device according to claim 19, wherein the set of records is available from a remote source, such as an Internet service to retrieve information for a fingerprint or a storage device in a local network to which the device is connected.

24. The device according to claim 19, wherein the fingerprint calculator and/or the matching means are comprised in an external device with which the device communicates over a network such as the Internet or a local network.

25. The device according to claim 15, wherein the monitoring means are configured for detecting an interruption in the receiving of the segment and for controlling the substitution means to cease the substituting of the segment by the substitution content item upon detection of the interruption.

26. The device according to claim 15, wherein the substitution means are configured for substituting the segment by a sequence of plural substitution content items from the second source whose combined length approximates the length of the segment.

27. The device according to claim 15, comprising a processor en memory which is programmable with instructions which are executable by the processor.

28. Method of rendering content from a first source comprising:
receiving the content from the first source,
receiving a substitution content item from a second source,
substituting a segment of the content with the substitution content item,
monitoring the receiving of the segment from the first source, and controlling the substituting means to cease the substituting dependent on the receiving of the segment, such that the substitution means cease the substituting when the receiving of the segment ceases.

29. Computer program product, comprising a data carrier having stored thereon machine executable instructions, which when loaded into and executed by a device according to claim 15, performs the steps of:
receiving the content from the first source,
receiving the substitution content item from the second source,
substituting the segment of the content with the substitution content item,
monitoring the receiving of the segment from the first source, and controlling the substituting means to cease the substituting dependent on the receiving of the segment, such that the substitution means cease the substituting when the receiving of the segment ceases.
